(19) United States
(12) Patent Application Publication
(10) Pub. No.: US 2024/0040661 A1
(43) Pub. Date: Feb. 1, 2024

(54) METHOD AND APPARATUS FOR PROVIDING BROADCAST SERVICE IN WIRELESS COMMUNICATION SYSTEM

(71) Applicant: Samsung Electronics Co., Ltd., Suwon-si (KR)

(72) Inventor: Youngkyo BAEK, Suwon-si (KR)

(21) Appl. No.: 18/359,689

(22) Filed: Jul. 26, 2023

(30) Foreign Application Priority Data
Jul. 28, 2022 (KR) 10-2022-0093797

(51) Int. Cl. H04W 76/40; H04W 4/06

(52) U.S. Cl. CPC H04W 76/40; H04W 4/06

(57) ABSTRACT

The disclosure relates to a 5G or 6G communication system for supporting a higher data transmission rate. A method performed by a base station in wireless communication system, the method comprising: identifying a second temporary mobile group identity (TMGI) which is different from a first TMGI for a broadcast service, and transmitting, to an access and mobility function (AMF), information on the second TMGI, and receiving, from the AMF, information on a broadcast session allocated by the MB-SMF (multicast/broadcast-session management function) based on the information on the second TMGI, receiving, from MB-UPF, broadcast data for broadcasting to user equipment (UE).

### CROSS-REFERENCE TO RELATED APPLICATIONS

This application is based on and claims priority under 35 U. S.C. § 119 to Korean Patent Application No. 10-2022-0093797, filed on Jul. 28, 2022, in the Korean Intellectual Property Office, the disclosure of which is herein incorporated by reference in its entirety.

### BACKGROUND

### 1. Field

The disclosure relates to a wireless communication system, and relates to a method and an apparatus for providing a broadcast service.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

As described above and according to the development of a wireless communication system, various services can be provided, whereby a method for seamlessly providing such services is required. Specifically, a technique for providing a broadcast service in a wireless communication system is required.

The above information is presented as background information only to assist with an understanding of the disclosure. No determination has been made, and no assertion is made, as to whether any of the above might be applicable as prior art with regard to the disclosure.

### SUMMARY

Various embodiments of the disclosure provide an apparatus and a method for effectively providing a service in a wireless communication system.

According to embodiments of the disclosure, a method performed by a base station in a wireless communication system may include receiving information on a broadcast service related to a first primary temporary mobile group identity (TMGI) from an application function (AF), identifying whether updating to a secondary primary TMGI is required, the second primary TMGI being different from the first primary TMGI, transmitting a first message related to the second primary TMGI to an access and mobility management function (AMF) when the updating to the second primary TMGI is required, and receiving a second message related to the second primary TMGI from the AMF as a response to the first message, wherein the base station is shared to provide a service between a first operator and a second operator.

According to embodiments of the disclosure, a method performed by an application function (AF) in a wireless communication system may include transmitting information on a broadcast service related to a first primary temporary mobile group identity (TMGI) to a base station, receiving, from a network exposure function (NEF), a first message including information indicating that a broadcast session for the first primary TMGI has been released, and transmitting a second message including information on a second primary TMGI to the NEF, the second primary TMGI being different from the first primary TMGI, wherein the base station is shared between a first operator and a second operator to provide a service.

According to embodiments of the disclosure, a method performed by a base station in a wireless communication system may include receiving information on a broadcast service related to a first primary temporary mobile group identity (TMGI) from an application function (AF), receiving, from an access and mobility management function (AMF), a first message including information for deletion of the broadcast service related to the first primary TMGI, identifying whether updating to a second primary TMGI is required, the second primary TMGI being different from the first primary TMGI, and transmitting information on the second primary TMGI, wherein the base station is shared between a first operator and a second operator to provide a service.

According to embodiments of the disclosure, a method performed by an application function (AF) in a wireless communication system may include transmitting information on a broadcast service related to a first primary temporary mobile group identity (TMGI) to a base station, identifying whether updating to a second primary TMGI is required, the second primary TMGI being different from the first primary TMGI, and transmitting, to a session management function (SMF) through a network exposure function (NEF), a first message including information for deletion of the broadcast service related to the first primary TMGI, wherein the first message includes information on the second primary TMGI, and the base station is shared between a first operator and a second operator to provide a service.

Various embodiments of the disclosure provide an apparatus and a method for effectively providing a service in a wireless communication system.

Effects obtainable from the disclosure are not limited to the above-mentioned effects, and other effects which are not mentioned may be clearly understood by those skilled in the art of the disclosure through the following descriptions.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of a structure of a 5G system in a wireless communication system according to an embodiment of the present disclosure;

FIG. 2 illustrates an example of a configuration of a base station in a wireless communication system according to an embodiment of the present disclosure;

FIG. 3 illustrates an example of a configuration of a terminal in a wireless communication system according to an embodiment of the present disclosure;

FIG. 4 illustrates an example of a configuration of an network entity in a wireless communication system according to an embodiment of the present disclosure;

FIG. 5 illustrates an example of a situation in which a servicing operator changes in a case of RAN sharing in a wireless communication system according to an embodiment of the present disclosure;

FIG. 6 illustrates an example of a process for generating a broadcast session for a broadcast service through a shared base station in a wireless communication system according to an embodiment of the present disclosure;

FIG. 7 illustrates an example of a method for updating a primary TMGI when a RAN is shared in a wireless communication system according to an embodiment of the present disclosure;

FIG. 8 illustrates another example of a method for updating a primary TMGI when a RAN is shared in a wireless communication system according to an embodiment of the present disclosure;

FIG. 9 illustrates an example of a method for updating a primary TMGI when an operator servicing the primary TMGI does not provide a service in a wireless communication system according to an embodiment of the present disclosure; and

FIG. 10 illustrates another example of a method for updating a primary TMGI when an operator servicing the primary TMGI does not provide a service in a wireless communication system according to an embodiment of the present disclosure.

### DETAILED DESCRIPTION

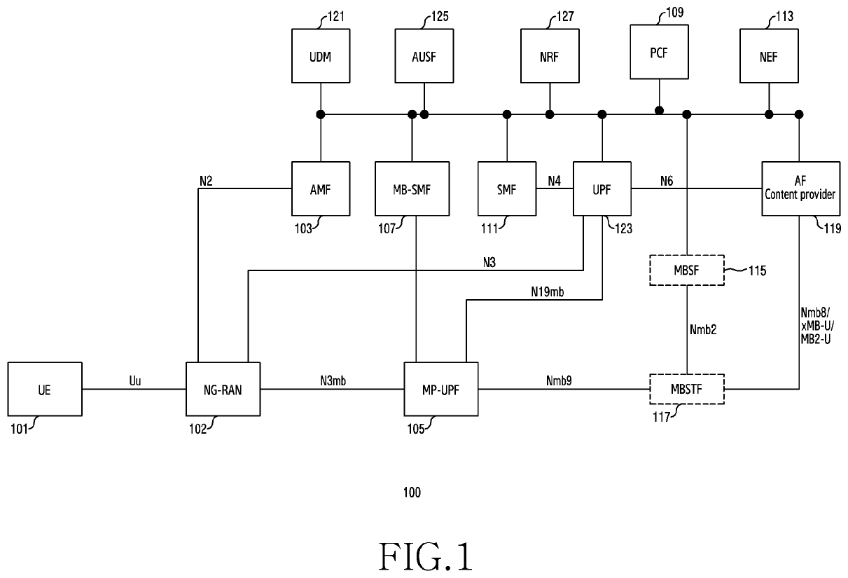

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, the operation principle of the disclosure will be described in detail with reference to the accompanying drawings. In describing the disclosure below, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” or may be implemented to reproduce one or more CPUs within a device or a security multimedia card. Furthermore, the “unit” in the embodiments may include one or more processors.

In the following description of the disclosure, a detailed description of known functions or configurations incorporated herein will be omitted when it is determined that the description may make the subject matter of the disclosure unnecessarily unclear.

In the following description, terms for identifying access nodes, terms referring to network entities (NEs), terms referring to messages, terms referring to interfaces between NEs, terms referring to various identification information, and the like are illustratively used for the sake of descriptive convenience. Therefore, the disclosure is not limited by the terms as used below, and other terms referring to subjects having equivalent technical meanings may be used.

The terms used in the disclosure are only used to describe specific embodiments, and are not intended to limit the disclosure. A singular expression may include a plural expression unless they are definitely different in a context. Unless defined otherwise, all terms used herein, including technical and scientific terms, have the same meaning as those commonly understood by a person skilled in the art to which the disclosure pertains. Such terms as those defined in a generally used dictionary may be interpreted to have the meanings equal to the contextual meanings in the relevant field of art, and are not to be interpreted to have ideal or excessively formal meanings unless clearly defined in the disclosure. In some cases, even the term defined in the disclosure should not be interpreted to exclude embodiments of the disclosure.

Hereinafter, various embodiments of the disclosure will be described based on an approach of hardware. However, various embodiments of the disclosure include a technology that uses both hardware and software, and thus the various embodiments of the disclosure may not exclude the perspective of software.

In the following description of the disclosure, terms and names defined in the LTE and NR standards, which are the latest standards specified by the 3rd generation partnership project (3GPP) group among the existing communication standards, are used for the sake of descriptive convenience. However, the disclosure is not limited by these terms and names, and may be applied in the same way to systems that conform other standards. In particular, the disclosure may be applied to the 3GPP NR (5th generation mobile communication standards). Furthermore, based on determinations by those skilled in the art, embodiments of the disclosure may also be applied to other communication systems having similar technical backgrounds or channel types through some modifications without significantly departing from the scope of the disclosure.

Hereinafter, the disclosure relates to a wireless communication system, and provides a method and an apparatus for efficiently performing broadcast data transmission. Specifically, the disclosure provides a method for updating a session for a broadcast service in a shared base station. When multiple operates share an NG-RAN in a wireless communication system supporting a broadcast service (that is, when an NG-RAN is shared in a multi-operator core network (MOCN) scheme), and when each of the operators provides the same service from the same broadcast service provider, the NG-RAN may provide a service through a single temporary mobile group identity (TMGI) (e.g., a primary TMGI). Described is a technique for performing updating of a primary TMGI when resources are saved and used through reduction of overlapping broadcast data transmissions as an NG-RAN provides a service through a single TMGI.

In the description, terms for identifying access nodes, terms referring to network entities, terms referring to messages, terms referring to interfaces between network entities, terms referring to various identification information, and the like have been illustratively used for the convenience of description. Therefore, the disclosure is not limited by the terms as used below, and other terms referring to subjects having equivalent technical meanings may be used. For example, In the following description, terms referring to signals (e.g., message, information, preamble, signal, signaling, sequence, and stream), terms for operational states (e.g., step, operation, and procedure), terms referring to data (e.g., packet, user stream, information, bit, symbol, and codeword), terms referring to channels, terms referring to control information (e.g., downlink control information (DCI), medium access control control element (MAC CE), and radio resource control (RRC) signaling, terms referring to network entities, terms referring to interfaces between network entities (e.g., N1, N2, and N3), terms referring to device elements, and the like are illustratively used for the sake of descriptive convenience. Therefore, the disclosure is not limited by the terms as used below, and other terms referring to subjects having equivalent technical meanings may be used.

In the disclosure, various embodiments will be described using terms employed in some communication standards (e.g., the 3rd generation partnership project (3GPP)), but they are only for the sake of illustration. The embodiments of the disclosure may also be easily applied to other communication systems through modifications.

To provide a broadcast service, a 5G system (5GS) may receive broadcast service data from an application function (AF) or a contents provider. The 5GC may transfer the broadcast service data to a new generation radio access network (NG-RAN) to transmit the broadcast service data to terminals at desired locations. According to an embodiment of the disclosure, the NG-RAN may include a base station. In a 5G core network, broadcast data may be transferred to the NG-RAN corresponding to a base station of a 5G network through shared delivery. That is, when the NG-RAN has a multicast/broadcast service (MBS) capability, broadcast service data may be transmitted from a user plane function (multicast/broadcast user plane function (MB-UPF)) for providing a broadcast service to the NG-RAN through a tunnel for the shared delivery. For convenience of description, a 5G network is described as an example, but limited interpretation that the embodiments of the disclosure is applied only to a 5G core network or a 5G network should not be made.

In a case where an NG-RAN, as an MOCN, is used among multiple operators through RAN sharing, when a contents provider provides the same broadcast service to the respective operators, the NG-RAN may perform broadcasting based on a primary temporary mobile group identity (TMGI). In this case, due to a situation of the NG-RAN, a change in an operator network through which the primary TMGI is serviced, or the like, updating of the primary TMGI may be required.

Hereinafter, an apparatus and a method according to an embodiment of the disclosure may perform updating of a primary TMGI when operators provide the same broadcast service in an NG-RAN used by the operators through RAN sharing in a 5G system (5GS) and the broadcast service is provided while use of overlapping resources is reduced through the primary TMGI. Accordingly, the apparatus and the method according to an embodiment of the disclosure may continuously provide the broadcast service through the updating of the primary TMGI.

Based on the above-described discussion, the disclosure relates to a wireless communication system, wherein when multiple operators share an NG-RAN in a wireless communication system supporting a broadcast service (that is, when the NG-RAN is shared in a multi-operator core network (MOCN) scheme), and when each of the operators provides the same service from the same broadcast service provider, the NG-RAN may provide a broadcast service through a primary TMGI. The disclosure provides a method and an apparatus for updating the primary TMGI when an NG-RAN provides a broadcast service while use of overlapping resources is reduced.

In addition, the disclosure provides a method and an apparatus for operation of terminals for continuously receiving broadcast data when a primary TMGI is updated in a RAN-sharing NG-RAN for providing broadcast service data in a wireless communication system.

Advantageous effects obtainable from the disclosure may not be limited to the above mentioned effects, and other effects which are not mentioned may be clearly understood, through the following descriptions, by those skilled in the art to which the disclosure pertains.

Furthermore, in the following description, terms and names defined in the % G system standards are used for the sake of descriptive convenience. However, the disclosure is not limited by these terms and names, and may be applied in the same way to systems that conform other standards.

FIG. 1 illustrates an example of a structure of a 5G system (5GS) in a wireless communication system according to an embodiment of the present disclosure. A 5G system (5GS) 100 of FIG. 1 is an example for convenience of description, and interpretation that the embodiment of the disclosure is only applicable to the structure of the 5GS 100 of FIG. 1 should not be made.

Referring to FIG. 1, the 5GS 100 may include a user equipment (UE) 101, an NG-RAN 102 corresponding to a base station, an access and mobility management function (AMF) 103, a multicast/broadcast user plane function (MB-UPF) 105, a multicast/broadcast-session management function (MB-SMF) 107, a policy control function (PCF) 109, a session management function (SMF) 111, a network exposure function (NEF) 113, a multicast/broadcast service function (MB SF) 1115, a multicast/broadcast service traffic function (MBSTF) 117, an application function (AF) device or contents provider, unified data management (UDM) 121, a user plane function (UPF) 123, an authentication server function (AUSF) 125, and an NF repository function (NRF) 127. Network entities included in the 5GS 100 are not limited to the example above, and the 5GS 100 may include more or fewer configurations than the configuration illustrated in FIG. 1. Here, each device may be referred to as a network entity, a network function, or a network function apparatus.

Referring to FIG. 1, respective network functions (NFs) of the 5GS 100 are described as a “network entity” or a “network function” itself. However, it is apparent to those skilled in the art that an NF and/or an NF device may be implemented in one server or two or more servers, and two or more NFs performing the same operation may be implemented in a single server.

In addition, according to an embodiment of the disclosure, one NF or two or more NFs may be implemented as one network slice. The network slice may be generated based on a specific purpose. For example, the network slice may be configured for a subscriber group for provision of the same type of service (e.g., a maximum transmission rate and data usage, a guaranteed minimum transmission rate, etc.) to specific subscriber groups. In addition, the network slice may be implemented according to various purposes.

Referring to FIG. 1, FIG. 1 illustrates interfaces between among respective nodes of the 5GS 100. For example, a Uu interface may be used between the UE 101 and the NG-RAN 102. An N2 interface may be used between the NG-RAN 102 and the AMF 103. An N3 interface may be used between the NG-RAN 102 and the UPF 123. An N3mb interface may be used between the NG-RAN 102 and the MB-UPF 105. In addition, an N4mb interface may be used between the MB-UPF 105 and the MB-SMF 107. An N19mb interface may be used between the MB-UPF 105 and the UPF 123. An N4 interface may be used between the SMF 111 and the UPF 123. An N6 interface may be used between the UPF 123 and the AF 119. An Nmb2 interface may be used between the MBSF 115 and the MB STF 117. In addition, an Nm9 interface may be used between the MB-UPF 105 and the MB STF 117. An Mmb8/xMB-U/MB2 interface may be used between the AF 119 and the MBSTF 117. The interfaces are defined in detail in the NR standard, and thus a detailed description thereof is omitted.

In general, in order to support a broadcast service in the 5GS 100, a cellular system for the broadcast service may be configured based on the following network function (NF) devices and services.

According to an embodiment of the disclosure, the AF 119 may provide various services. For example, the AF 119 may be a V2X application server, a cellular Internet of Things (CIoT), an application server, a mission-critical push-to-talk (MCPTT) application, a contents provider, a TV or audio service provider, a streaming video service provider, etc.

In addition, the AF 119 may request MBS service provision from the MBSF 115 corresponding to an NF for controlling session management and traffic of an MBS service to provide the MBS service. The MBSF 115 may be an NF for receiving the request for the MBS service from the AF 119 so as to manage the MBS service session and control the MBS service traffic. In addition, the MBSTF 117 may be an NF for receiving, based on the control of the MBSF 115, media from a contents provider, an application server (AS) for providing the MBS, or an AF for providing the MBS, so as to process media traffic. That is, the MBSTF 117 may operate as an MBS service anchor in the 5GS 100.

In the 5G core network (5GC), an MBS system may be configured and operated without including the MBSF 115 and the MBSTF 117. When the MB SF 115 and the MBSTF 117 are not included, the AF 119 may request MBS service provision directly from the MB-SMF 107, or from the MB-SMF 107 through the NEF 113. In this case, the MBS data may be provided from the application server (AS) for providing the MBS or from the contents provider to the 5G network through the MB-UPF 105.

In the disclosure, the AF 119 may be an application server (AS) for providing a specific broadcast application service. Accordingly, the AS below may be understood to be identical to the AF 119, or to be present together with the AF 119. To provide the MBS service to the UE 101, the AF 119 may transmit a request for MBS service provision to the MBSF 115. The MBSF 115 may control the MBSTF 117 corresponding to an MBS service media anchor in the 5GS 100, which transmits MBS service traffic to the UE 101. Accordingly, the MBSF 115 may provide the MBS service to the UE 101. In this case, the MBS service may mean data according to the multicast/broadcast service, received from a specific contents provider.

According to an embodiment, the MBSF 115 and the MBSTF 117 may be configured to be integrated as one entity or one NE In addition, the MBSF 115 may be configured to be integrated with the NEF 113 or another NE In addition, in the 5GS 100, the AF 119 may directly request the MBS service from the MB-SMF 107 without the MBSF 115 and the MBSTF 117, and the MB-UPF 105 may receive media from the contents provider corresponding to the AS or the AF 119 and forward traffic.

According to an embodiment, the MBS service may be managed and service traffic may be generated through the MBSF 115 and the MBSTF 117. Here, when service traffic is transferred to the UE 101 via broadcast, the MBSF 115 may manage an MBS service, the MB-SMF 107 may allocate an MBS session, and the MBSTF 117 may operate as a media anchor of the corresponding MBS traffic. That is, the MBSF 115 may correspond to a control plane for managing the MBS service, and the MBSTF 117 may correspond to a user plane for managing the MBS traffic.

Hereinafter, in the disclosure, the term “multimedia broadcast-multicast service gateway-control plane (MBMS-GW-C)” may be used to collectively refer to a control function or service for generating an MBS context for an MBS PDU session, managing an MBs session, and transferring traffic of the MBS session to an NG-RAN 102 corresponding to a base station via IP multicast.

The MBMS-GW-C service may be integrated with the existing SMF 111 for managing a unicast PDU session and configured as an SMF 111 having an MBS session control function, or may be configured as a separate NF. Hereinafter, in the disclosure, an NF which supports the MBMS-GW-C service and also has a function of the existing SMF is referred to as an MF-SMF 107.

In addition, in the disclosure, a service for transferring traffic received from the MB-UPF 105 according to the MBS context for the MBS PDU session to the NG-RAN 102 for performing multicasting/broadcasting according to the MBMS-GW-C service, via IP multicast, is referred to as a multimedia broadcast-multicast service gateway-user plane (MBMS-GW-U) service.

The MBMS-GW-U service may be integrated with the existing UPF for processing a unicast PDU session and configured as an UPF having a function of transferring MB S traffic to a proper NG-RAN 102 via IP multicast, or may be configured as a separate NF as illustrated in FIG. 1. Accordingly, hereinafter, in the disclosure, an NF which supports the MBMS-GW-U service and also has a function of the existing UPF is referred to as an MB-UPF 105.

As described above, the MBMS-GW-C service may use the N4mb interface to control the MBMS-GW-U service.

In describing embodiment of the disclosure, for convince of description, the MBMS-GW-C and the MBMS-GW-U may be referred as the MB-STF 107 and the MB-UPF 105, respectively.

The MBS traffic may be transferred from the MBMS-GW-U (or the MB-UPF 105) to the NG-RAN 102. For example, the MBS traffic may be transferred to the NG-RAN 102 by using IP multicast, or may be transferred to the NG-RAN 102 by using a unicast tunnel. In this case, a tunnel between the MBMS-GW-U (or the MB-UPF 105) and the NG-RAN 102 may be called a shared delivery tunnel. Hereinafter, for convenience of description, a tunnel between the MBMS-GW-U and the NG-RAN 102 may be referred to as a shared delivery tunnel or a shared tunnel.

To configure a shared delivery tunnel, the MBMS-GW-C (or the MB-SMF 107) may transmit a control message to the NG-RAN 102 through the AMF 103.

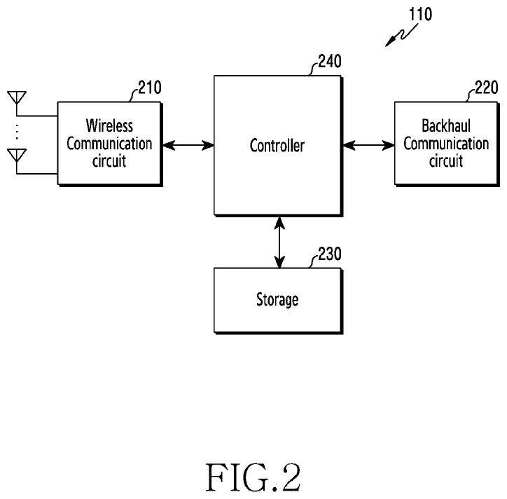

FIG. 2 illustrates an example of a configuration of a base station in a wireless communication system according to an embodiment of the present disclosure. The configuration of a base station 102 illustrated in FIG. 2 may be understood as the configuration of the NG-RAN 102 of FIG. 1. The terms “ . . . unit,” “ . . . device,” etc. used hereinafter refer to a unit for processing at least one function or operation, and may be implemented as hardware, software, or a combination of hardware and software.

Referring to FIG. 2, the base station 102 may include a wireless communication circuit 210, a backhaul communication circuit 220, a storage 230, and a controller 240.

The wireless communication circuit 210 performs functions for transmitting or receiving a signal via a wireless channel. For example, the wireless communication circuit 210 performs a function of conversion between a baseband signal and a bitstream according to a physical layer specification of a system. For example, during data transmission, the wireless communication circuit 210 generates complex symbols by encoding and modulating a transmission bitstream. When receiving data, the wireless communication circuit 210 restores a reception bitstream by demodulating and decoding a baseband signal.

In addition, the wireless communication circuit 210 up-converts a baseband signal to a radio frequency (RF) band signal, then transmits the up-converted RF band signal via an antenna, and down-converts an RF band signal received via an antenna to a baseband signal. To this end, the wireless communication circuit 210 may include a transmission filter, a reception filter, an amplifier, a mixer, an oscillator, a digital-to-analog converter (DAC), an analog-to-digital converter (ADC), and the like. In addition, the wireless communication circuit 210 may include multiple transmission/reception paths. Furthermore, the wireless communication circuit 210 may include at least one antenna array including multiple antenna elements.

In terms of hardware, the wireless communication circuit 210 may include a digital unit and an analog unit, wherein the analog unit includes multiple sub-units according to an operation power, an operation frequency, and the like. The digital unit may be implemented as at least one processor (e.g., a digital signal processor (DSP)).

The wireless communication circuit 210 transmits and receives a signal as described above. Accordingly, all or a part of the wireless communication circuit 210 may be referred to as a “transmitter,” “a “receiver,”” or a “transceiver.” In addition, in the following description, transmission and reception performed via a wireless channel are used as a meaning including the above-described processing being performed by the wireless communication circuit 210.

The backhaul communication circuit 220 provides an interface for performing communication with other nodes within a network. That is, the backhaul communication circuit 220 converts, into a physical signal, a bitstream transmitted from a base station to another node, for example, another access node, another base station, a higher node, a core network, etc., and converts a physical signal received from another node into a bitstream.

The storage 230 stores data, such as a basic program, an application program, configuration information, and the like for operation of the base station. The storage 230 may include a volatile memory, a non-volatile memory, or a combination of a volatile memory and a non-volatile memory. The storage 230 provides stored data according to a request of the controller 240.

The controller 240 controls overall operations of the base station. For example, the controller 240 transmits and receives a signal via the wireless communication circuit 210 or the backhaul communication circuit 220. In addition, the controller 240 records and reads data in and from the storage 230. In addition, the controller 240 may perform functions of a protocol stack required by the communication standard. According to another implementation example, the protocol stack may be included in the wireless communication circuit 210. To this end, the controller 240 may include at least one processor. According to various embodiments, the controller 240 may perform control to perform synchronization using a wireless communication network. For example, the controller 240 may control the base station to perform operations according to various embodiments described below.

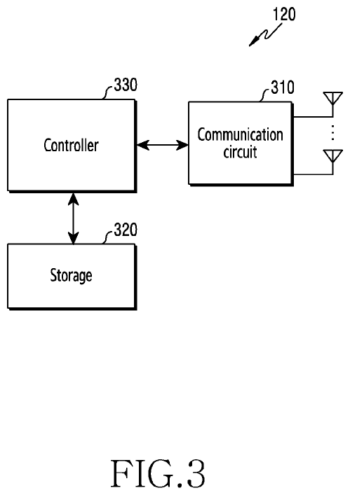

FIG. 3 illustrates an example of a configuration of a terminal in a wireless communication system according to an embodiment of the present disclosure. The configuration of a terminal 101 illustrated in FIG. 3 may be understood as the configuration of the UE 101 of FIG. 1. The terms “ . . . unit” “ . . . device,” etc. used hereinafter refer to a unit for processing at least one function or operation, and may be implemented as hardware, software, or a combination of hardware and software.

Referring to FIG. 3, the terminal 101 may include a communication circuit 310, a storage 320, and a controller 330.

The communication circuit 310 performs functions for transmitting or receiving a signal via a wireless channel. For example, the communication circuit 310 performs a function of conversion between a baseband signal and a bitstream according to a physical layer specification of the system. For example, during data transmission, the communication circuit 310 generates complex symbols by encoding and modulating a transmission bitstream. When receiving data, the communication circuit 310 restores the received bitstream by demodulating and decoding the baseband signal. In addition, the communication circuit 310 up-converts the baseband signal into an RF band signal, then transmits the up-converted RF band signal via an antenna, and down-converts an RF band signal received via an antenna into a baseband signal. For example, the communication circuit 310 may include a transmission filter, a reception filter, an amplifier, a mixer, an oscillator, a DAC, an ADC, and the like.

In addition, the communication circuit 310 may include multiple transmission/reception paths. Furthermore, the communication circuit 310 may include at least one antenna array including multiple antenna elements. In terms of hardware, the communication circuit 310 may include a digital circuit and an analog circuit (e.g., a radio frequency integrated circuit (RFIC)). The digital circuit and the analog circuit may be implemented in a single package. In addition, the communication circuit 310 may include multiple RF chains. Furthermore, the communication circuit 310 may perform beamforming.

The communication circuit 310 transmits and receives a signal as described above. Accordingly, all or a part of the communication circuit 310 may be referred to as “transmitter,” “receiver,” “or “transceiver.” In addition, in the following description, transmission and reception performed via a wireless channel are used as a meaning including the above-described processing being performed by the communication circuit 310.

The storage 320 stores data, such as a basic program, an application program, configuration information, and the like for operation of the terminal. The storage 320 may include a volatile memory, a non-volatile memory, or a combination of a volatile memory and a non-volatile memory. The storage 320 provides stored data upon a request of the controller 330.

The controller 330 controls overall operations of the terminal. For example, the controller 330 transmits and receives a signal via the communication circuit 310. In addition, the controller 330 records and reads data in and from the storage 320. The controller 330 may perform functions of a protocol stack required by the communication standard. To this end, the controller 330 may include at least one processor or a micro-processor, or may be a part of a processor. In addition, a part of the communication circuit 310 and the controller 330 may be referred to as a communication processor (CP). According to various embodiments, the controller 330 may perform control to perform synchronization using a wireless communication network. For example, the controller 330 may control the terminal to perform operations according to various embodiments described below.

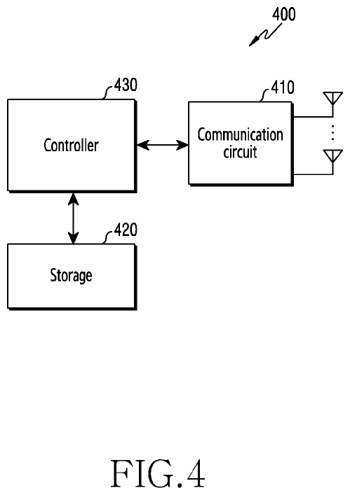

FIG. 4 illustrates an example of a configuration of an network entity in a wireless communication system according to an embodiment of the present disclosure. A network entity 400 illustrated in FIG. 4 may be understood as a configuration of a device having at least one function from among the AMF 103, the MB-UPF 105, the MB-SMF 107, the PCF 109, the SMF 111, the NEF 113, the MB SF 115, the MB STF 117, the AF 119, the UDM 121, the UPF 123, the AUSF 125, and the NRF127 of FIG. 1. The terms “ . . . unit” “ . . . device,” etc. used hereinafter refer to a unit for processing at least one function or operation, and may be implemented as hardware, software, or a combination of hardware and software.

Referring to FIG. 4, a network entity 400 may include a communication circuit 410, a storage 420, and a controller 430.

The communication circuit 410 provides an interface for performing communication with other devices within the network. That is, the communication circuit 410 converts, into a physical signal, a bitstream transmitted from the network entity to another device, and converts a physical signal received from another device into a bitstream. That is, the communication circuit 410 may transmit and receive a signal. Accordingly, the communication circuit 410 may be referred to as a modem, a transmitter, a receiver, or a transceiver. In this case, the communication circuit 410 enables the network entity to communicate with other devices or systems via a network or a backhaul connection (e.g., a wired backhaul or a wireless backhaul).

The storage 420 stores data, such as a basic program, an application program, and configuration information for an operation of the network entity. The storage 420 may include a volatile memory, a non-volatile memory, or a combination of a volatile memory and a non-volatile memory. The storage 420 provides stored data upon a request of the controller 430.

The controller 430 controls overall operations of the core network entity. For example, the controller 430 transmits and receives a signal via the communication circuit 410. In addition, the controller 430 records and reads data in and from the storage 420. To this end, the controller 430 may include at least one processor. According to various embodiments, the controller 430 may perform control to perform synchronization using a wireless communication network. For example, the controller 430 may control the network entity to perform operations according to various embodiments to be described below.

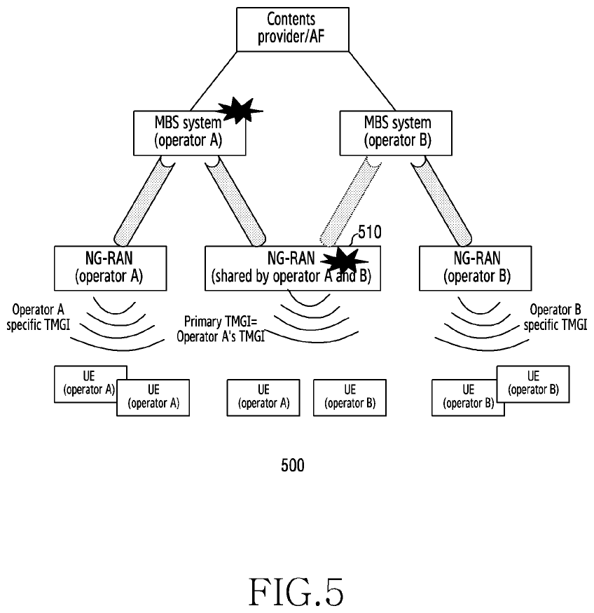

FIG. 5 illustrates an example of a situation in which a servicing operator changes in a case of RAN sharing in a wireless communication system according to an embodiment of the present disclosure. Specifically, in a situation 500 of FIG. 5, an example of a situation in which an operator providing a service in an NG-RAN or a 5GC changes while the same broadcast service is being provided through the RAN sharing NR-RAN in the wireless communications system is illustrated.

Referring to FIG. 5, a broadcast service may be executed through an MBS system through operator A, and the same broadcast service may be executed through an MBS system through operator B. In this case, operator A and operator B may share a specific NG-RAN. In a case of a RAN sharing NG-RAN 510, actually broadcasted data may be overlapped and broadcasted through operator A and operator B. In this case, the RAN sharing NG-RAN 510 may provide a broadcast service by configuring a TMGI of operator A as a primary TMGI. Broadcast data transferred from the MB-UPF to the NG-RAN through a network of operator B is identical to that transferred through a network of operator A, and thus a shared tunnel from the MB-UPF of the network of operator B to the NG-RAN may be deleted.

In relation to Case #1, the NG-RAN 510 may no longer support the network of operator A. Accordingly, the broadcast service needs to be continuously provided when the primary TMGI needs to be updated. Alternatively, in relation to Case #2, the network of operator A may no longer support the broadcast service. Accordingly, the broadcast service needs to be continuously provided when the primary TMGI needs to be updated. As described above, the disclosure provides a method for continuously providing the broadcast service even when the primary TMGI is updated.

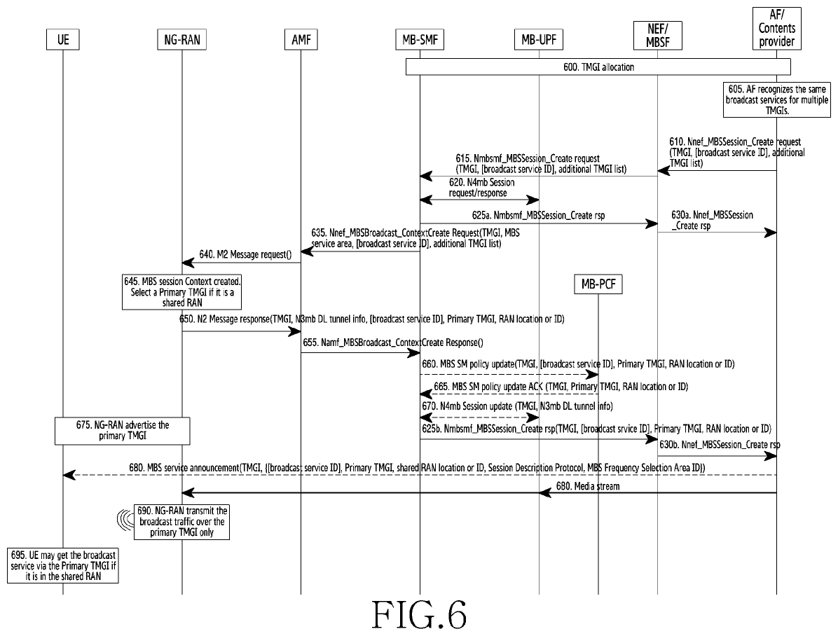

FIG. 6 illustrates an example of a process for generating a broadcast session for a broadcast service through a shared base station in a wireless communication system according to an embodiment of the present disclosure. A UE, an NG-RAN, an AMF, an MB-SMF, an MB-UPF, an NEF/MBSF, and an AF (contents provider), which are described in FIG. 6, may be understood to be identical to the network entities included in the 5GS 100 of FIG. 1. In addition, an MB-PCF of FIG. 6 may be understood to be substantially identical to the PCF 109 of FIG. 1. For example, the MB-PCF of FIG. 6 may refer to a PCF capable of providing a service related to an MBS in relation to the PCF 109 of FIG. 1.

According to an embodiment, in operation 600, the AF may receive an allocation of a temporary mobile group identity (TMGI) from the MB-SMF through the NEF to generate a broadcast session (MBS session) for a broadcast service.

In operation 605, the AF may identify that the same broadcast service is provided in a network of another operator before requesting the MBS session from the MB-SMF for the TMGI. In addition, the AF may identify TMGI values used by each operator. That is, the AF may identify a list of one or more TMGIs for providing the broadcast service. Here, the TMGI may include information of an operator for providing the broadcast service. For example, the TMGI may include a public land mobile network (PLMN) ID. The TMGI may be information indicating an operator through which the broadcast service is provided. According to an embodiment, the AF may define a broadcast service ID value for indicating a broadcast service regardless of a network of an operator, separately from a TMGI value indicating a broadcast service for each network of an operator. In other words, the AF may identify that the broadcast service is provided for each operator, based on the TMGI value. In addition, the AF may identify that the broadcast service is provided for each service, based on a broadcast service ID.

In operation 610, the AF may transmit, to the NEF, a message for requesting MBS session generation for the TMGI. For example, the message for requesting the MBS session generation may be an Nnef_MBSSsession_Create request message. In operation 615, the NEF having received the message for requesting the MBS session generation may transmit an MBS session generation request message to the MB-SMF. For example, the message transmitted to the MB-SMF by the NEF may be an Nmbsmf_MBSSession_Create request message. In other words, in operations 610 and 615, the AF may request MBS session generation for the TMGI from the MB-SMF through the NEF in a specific operator network. That is, the AF may request the MBS session for the TMGI through the MBS session generation request message (e.g., Nnef_MBSSession_Create request and Nmbsmf_MBSSession_Create request messages). The MB S session generation request message may include at least one of a TMGI, a broadcast service ID, or a list of one or more TMGIs for providing the same broadcast service in another network. The TMGI list may or may not include a TMGI of an operator network. Here, the broadcast service ID and the TMGI list may be included in the MBS session generation request message when the NG-RAN shared among operators through RAN sharing is operated. That is, the broadcast service ID and the TMGI list may be used as information for identifying a situation in which the same broadcast service data is transmitted in the RAN sharing NG-RAN (or MOCN NG-RAN).

In operation 620, the MB-SMF may generate an N4mb session. In operation 625a, the MB-SMF may transmit a response to operation 610 to the NEF. In operation 630a, the NEF may transmit a response to operation 615 to the AF. Alternatively, a response to the AF may be transmitted to the AF after a broadcast session (MBS session) in an MBS network is generated as shown in operations 625b and 630b.

In operation 635, the MB-SMF having received the MBS session generation request for the broadcast service may transmit a broadcast session context generation request message (Namf_Broadcast_ContextCreate_request) to the AMF. In this case, the broadcast session content generation request message may include a TMGI to select an NG-RAN corresponding to an MBS service area. In addition, the broadcast session context generation request message may include a lower layer source specific IP multicast address (LL SSM) when the MB-UPF transmits data to NG-RANs via multicast. The broadcast session context generation request message may include the MBS service area. The broadcast session context generation request message may include the received broadcast service ID or list of one or more TMGIs for providing the same broadcast service.

In operation 640, the AMF may transmit an N2 message request to the NG-RAN by using the message received from the MB-SMF. The N2 message request may include the TMGI. In addition, the N2 message request may include a lower layer source specific IP multicast address (LL SSM) when the MB-UPF transmits data to NG-RANs via multicast. The N2 message request may include an MBS service area, and may include a service type set to be a broadcast service. The N2 message request may include the received broadcast service ID or list of one or more TMGIs for providing the same broadcast service. According to an embodiment, the N2 message request in operation 640 may include the received broadcast service ID or list of one or more TMGIs for providing the same broadcast service only when the NG-RAN corresponds to a RAN sharing NG-RAN (or MOCN NG-RAN). However, the disclosure is not limited thereto, and the N2 message request may include the broadcast service ID or the list of one or more TMGIs for providing the same broadcast service even when the NG-RAN does not correspond to the RAN sharing NG-RAN.

In operation 645, the NG-RAN may generate an MBS session context for the broadcast service. When the NG-RAN corresponds to a RAN sharing NG-RAN (or MOCN NG-RAN), a primary TMGI to be used when the NG-RAN transmits broadcast data may be selected, and the selected primary TMGI may be included in the MBS session context. The RAN sharing NG-RAN (or MOCN NG-RAN) may select, as a primary TMGI, a TMGI for a broadcast service provided by an operator who owns the NG-RAN. Alternatively, the RAN sharing NG-RAN (or MOCN NG-RAN) may select, as a primary TMGI, a TMGI for a broadcast service provided by an operator determined as an operator for providing the service to more UEs in the MBS service area, among operators sharing the NG-RAN. Alternatively, the RAN sharing NG-RAN (or MOCN NG-RAN) may select, as a primary TMGI, a TMGI for a broadcast service provided by an operator having the highest importance or the highest facility contribution, among operators sharing the NG-RAN and providing the same broadcast service.

When receiving LL SSM information from the MB-SMF through operations 635 and 640, the NG-RAN may also request joining to receive broadcast service data from the MB-UPF via multicast. However, the RAN sharing NG-RAN (or MOCN NG-RAN) may not request joining when a TMGI of an operator network is different from the primary TMGI.

In operations 650 and 655, the NG-RAN may transmit a response (e.g., an N2 message response and an Namf_MBSBroadcast_ContextCreate response) to operations 635 and 640 to the MB-SMF through the AMF. Through operations 650 and 655, TMGI information an N3mb DL tunnel information for reception of data to the NG-RAN may be transmitted. Accordingly, a tunnel for transferring broadcast service data may be generated between the NG-RAN and the MB-UPF. The message transmitted in operations 650 and 655 may include at least one of a broadcast service ID, primary TMGI information, or NG-RAN location information when the NG-RAN corresponds to a RAN sharing NG-RAN (or MOCN NG-RAN). Alternatively, the message transmitted in operations 650 and 655 may include a broadcast service ID, primary TMGI information, and NG-RAN location information when the NG-RAN corresponds to a RAN sharing NG-RAN (or MOCN NG-RAN). For example, the NG-RAN location information may include an ID, a cell ID, geographical location information, or geographical address information of the NG-RAN.

In operations 660 and 665, the MB-SMF may perform an MBS SM policy update process with the MB-PCF or the PCF. In case of a RAN sharing NG-RAN (or MOCN NG-RAN), the MB-SMF may perform the MBS SM policy update process to identify whether the MB-SMF allows the service to be provided using the primary TMGI. The MBS SM policy update message may include a part or all of the broadcast service ID, the primary TMGI information, the NG-RAN location information, other than the TMGI.

When the MB-SMF has receive a response that the RAN sharing NG-RAN can provide the service using the primary TMGI, the MB-SMF may generate a tunnel for transferring the broadcast service data between the NG-RAN and the MB-UPF in operation 670. In operations 625b and 630b, the MB-SMF may transfer a response to operations 610 and 615 to the AF. The message in operations 625b and 630b may include a part or all of the broadcast service ID, the primary TMGI information, or the NG-RAN location information. For example, the NG-RAN location information may include an ID, a cell ID, geographical location information, or geographical address information of the NG-RAN.

In operation 670, when the primary TMGI is different from the TMGI, the MB-SMF may not transmit downlink tunnel information to the NG-RAN to prevent data from being transmitted through the tunnel between the NG-RAN and the MB-UPF. Alternatively, the MB-SMF may transfer an indicator indicating the MB-UPF not to transmit broadcast data corresponding to the TMGI. Alternatively, when the primary TMGI is different from the TMGI, operation 670 may not be performed.

In operation 675, the RAN sharing NG-RAN (or MOCN NG-RAN) may perform broadcasting to transmit broadcast service data through the primary TMGI determined in operation 645, rather than the TMGI.

In operation 680, to provide the broadcast service through the RAN sharing NG-RAN (or MOCN NG-RAN), the AF may notify terminals of updated information through an MBS service announcement to notify that the primary TMGI is used rather than the TMGI. The MBS service announcement may include a part or all of a broadcast service ID, primary TMGI information, NG-RAN location information, an MBS frequency selection area ID, or a session description protocol, other than the TMGI information. For example, the NG-RAN location information may include at least one of an ID, a cell ID, geographical location information, or geographical address information of the NG-RAN.

In operation 690, the RAN sharing NG-RAN (or MOCN NG-RAN) may transmit traffic only for the broadcast service data received using the primary TMGI even though the broadcast service data is received using the TMGI through operation 685.

In operation 695, when being located in the RAN sharing NG-RAN (or MOCN NG-RAN), a terminal having received information on the use of the primary TMGI through operation 680 may receive the broadcast service data through the primary TMGI.

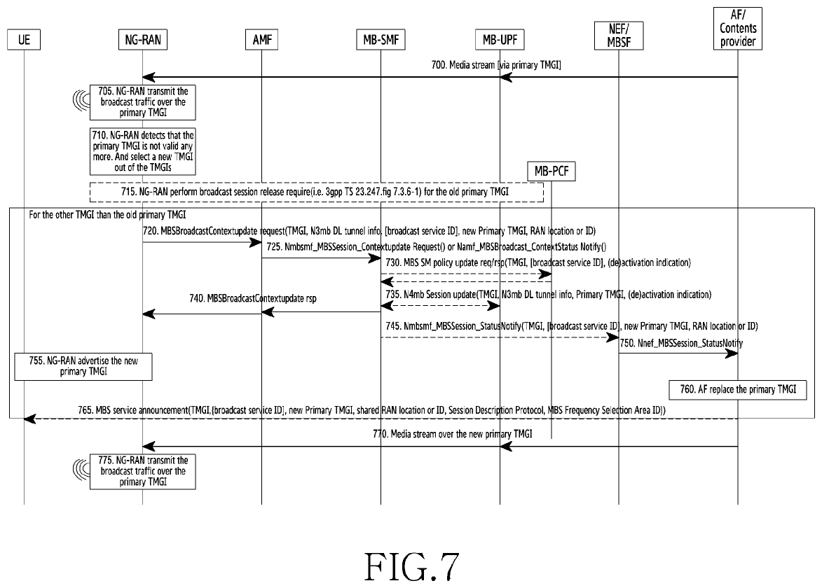

FIG. 7 illustrates an example of a method for updating a primary temporary mobile group identity (TMGI) when a RAN is shared in a wireless communication system according to an embodiment of the present disclosure. Specifically, FIG. 7 illustrates an example of a method for updating a primary TMGI by an NG-RAN when the primary TMGI is not valid in an RAN sharing NG-RAN in a wireless communication system.

A UE, an NG-RAN, an AMF, an MB-SMF, an MB-UPF, an NEF/MB SF, and an AF (contents provider), which are described in FIG. 7, may be understood to be identical to the network entities included in the 5GS 100 of FIG. 1. In addition, an MB-PCF of FIG. 7 may be understood to be substantially identical to the PCF 109 of FIG. 1. For example, the MB-PCF of FIG. 7 may refer to a PCF capable of providing a service related to an MBS in relation to the PCF 109 of FIG. 1.

In operation 700, the AF (or contents provider) may transmit broadcast service data to an RAN sharing NG-RAN. In operation 705, the NG-RAN may broadcast broadcast service data to terminals through a primary TMGI.

In operation 710, when the NG-RAN may no longer provide the broadcast service data through the primary TMGI, the NG-RAN may select, as a new primary TMGI, a TMGI of an operator for providing the same broadcast service, other than the primary TMGI, and identify that updating is required. For example, a case where the broadcast service cannot be provided any longer through the primary TMGI may be a case where a contract for RAN sharing of the NG-RAN is terminated for an operator servicing through the TMGI used as the primary TMGI, a case where it is determined that the broadcast service cannot be normally performed according to a policy of the operator servicing through the TMGI used as the primary TMGI, or a case where a resource allocated for the operator servicing through the TMGI used as the primary TMGI cannot be used due to a failure in the NG-RAN. In this case, the NG-RAN may need to select a new primary TMGI and perform updating.

The NG-RAN having selected the new primary TMGI may release a broadcast session having been serviced through the existing primary TMGI. In operation 715, the NG-RAN may transmit a broadcast session release require message to the AMF for the existing primary TMGI. The AMF may perform broadcast session releasing with the NG-RAN, and notify to the MB-SMF that the broadcast session has been released. The MB-SMF may perform N4mb session updating to delete a downlink tunnel between the MB-UPF and the NG-RAN. That is, in the broadcast session release require process, the broadcast session for the existing primary TMGI may be released according to FIG. 7.3.6-1 of 3GPP Ts 23.247.

A RAN sharing base station may update with a new primary TMGI for an operator servicing a TMGI other than the existing primary TMGI for providing the same broadcast service.

In operation 720, for the TMGI other than the existing primary TMGI, the RAN sharing NG-RAN may transmit an MBS broadcast context update request message to the AMF. The NG-RAN may transmit a request message (e.g., an MBSBroadcastConextupdate request) so as to notify the 5GC of the change of the primary TMGI and update a broadcast session context. The request message may include a new primary TMGI, and may include RAN location information or an NG-RAN ID to indicate a base station. The request message may include a broadcast service ID to identity that the service is the same broadcast service. In addition, the request message may also include information (e.g., N3mb DL tunnel information) on a tunnel for transmitting broadcast downlink data.

In operation 725, the AMF may transmit an Nmbsmf_MB_SSession_ContextUpdate request message to the MB-SMF. In this case, in operation 720, the AMF may forward the message received from the NG-RAN, or may transmit an Namf_MB_SBroadcast_ContextStatus notify message to the MB-SMF. The Namf_MB_SBroadcast_ContextStatus notify message may include a part or all of a new primary TMGI, RAN location information, an NG-RAN ID, a broadcast service ID, or N3mb DL tunnel information. Accordingly, the AMF may notify to the MB-SMF whether the primary TMGI has been changed.

In operation 730, the MB-SMF may perform SM policy updating with the MB-PCF. In operation 735, the MB-SMF may transmit an N4mb session update message including the new primary TMGI and the N3mb DL tunnel information to the MB-UPF. The N4mb session update message may include information on a tunnel for transmitting broadcast downlink data. In this case, a deactivation indicator may be included to prevent overlapping broadcast data from being transmitted to the NG-RAN when the corresponding TMGI is not the primary TMGI. Accordingly, the MB-UPF having received the deactivation indicator or having identify that the TMGI is different from the primary TMGI may not forward, to the NG-RAN, the broadcast service data transferred to the corresponding TMGI.

In operation 740, the MB-SMF may transmit an MBS broadcast context update response message to the NG-RAN through the AMF. The MB-SMF may transmit, to the NG-RAN, a result of processing of the broadcast session context update request. In operation 735, the NG-RAN may broadcast the broadcast data to the terminal through the newly allocated primary TMGI.

In operation 745, the MB-SMF may transmit information on the primary TMGI to the MB SF through an Nmbsmf_MBSSession_StatusNotify message. In operation 750, the NEF may transmit an Nnef_MB_SSession_StatusNotify message to the AF, based on the message received from the MB-SMF. The Nmbsmf_MBSSession_StatusNotify and Nnef_MBS_Session_StatusNotify messages may include a new primary TMGI, a broadcast service ID, base station location information, and an NG-RAN ID.

In operation 760, the AF may replace the primary TMGI. Accordingly, in operation 765, the AF may transmit a service announcement message to terminals. For example, the AF may transmit, to the terminal, information for receiving the broadcast service from the MOCN base station. In operations 770 and 775, the NG-RAN may broadcast the broadcast service data to the terminals by using the new primary TMGI.

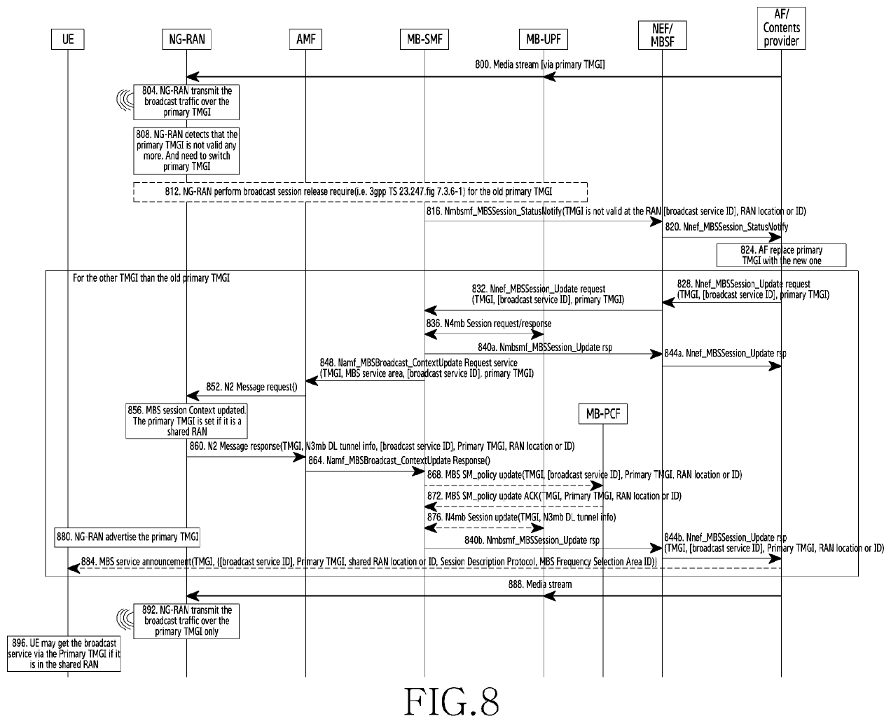

FIG. 8 illustrates another example of a method for updating a primary temporary mobile group identity (TMGI) when a RAN is shared in a wireless communication system according to an embodiment of the present disclosure. Specifically, FIG. 8 illustrates an example of a method for updating a primary TMGI through an AF when a primary TMGI is not valid in a RAN sharing NG-RAN in a wireless communication system.

A UE, an NG-RAN, an AMF, an MB-SMF, an MB-UPF, an NEF/MB SF, and an AF (contents provider), which are described in FIG. 8, may be understood to be identical to the network entities included in the 5GS 100 of FIG. 1. In addition, an MB-PCF of FIG. 8 may be understood to be substantially identical to the PCF 109 of FIG. 1. For example, the MB-PCF of FIG. 8 may refer to a PCF capable of providing a service related to an MBS in relation to the PCF 109 of FIG. 1.

In operation 800, the AF (or contents provider) may transmit broadcast service data to an RAN sharing NG-RAN. In operation 804, the NG-RAN may broadcast broadcast service data to terminals in the NG-RAN through a primary TMGI.

In operation 808, when the NG-RAN may no longer provide the broadcast service data through the primary TMGI, the NG-RAN may select, as a new primary TMGI, a TMGI of an operator for providing the same broadcast service, other than the primary TMGI, and identify that updating is required. For example, a case where the broadcast service cannot be provided any longer through the primary TMGI may be a case where a contract for RAN sharing of the NG-RAN is terminated for an operator servicing through the TMGI used as the primary TMGI, a case where it is determined that the broadcast service cannot be normally performed according to a policy of the operator servicing through the TMGI used as the primary TMGI, or a case where a resource allocated for the operator servicing through the TMGI used as the primary TMGI cannot be used due to a failure in the NG-RAN. In this case, the NG-RAN may need to select a new primary TMGI and perform updating.

The NG-RAN having selected the new primary TMGI may release a broadcast session having been serviced through the existing primary TMGI. In operation 812, the NG-RAN may transmit a broadcast session release require message to the AMF for the existing primary TMGI. The AMF may perform broadcast session releasing with the NG-RAN, and notify to the MB-SMF that the broadcast session has been released. The MB-SMF may perform N4mb session updating to delete a downlink tunnel between the MB-UPF and the NG-RAN. That is, in the broadcast session release require process, the broadcast session for the existing primary TMGI may be released according to FIG. 7.3.6-1 of 3GPP Ts 23.247.

In operation 816, the MB-SMF may transmit an Nmbsmf_MBSSession_StatusNotify message to the NEF to notify that the broadcast session through the existing primary TMGI has been released from the NG-RAN. In operation 820, the NEF having received the message for notifying that the broadcast session through the existing primary TMGI has been released may notify to the AF through an Nnef_MB_SSession_StatusNotify message that the broadcast session through the existing primary TMGI has been released. Here, the message transmitted to the NEF by the MB-SMF and the message transmitted to the AF by the NEF (e.g., Nmbsmf_MBSSession_StatusNotify and Nnef_MBSSession_StatusNotify) may include information (indication) for indicating that the corresponding TMGI cannot provide a service any longer in the NG-RAN. The messages (e.g., Nmbsmf_MB_SSession_StatusNotify and Nnef_MBSSession_StatusNotify) may include NG-RAN location information or an NG-RAN ID. In addition, the message (e.g., Nmbsmf_MB_SSession_StatusNotify and Nnef_MBSSession_StatusNotify) may include a broadcast service ID. In other words, the MB-SMF may notify the AF of information on an overlapping broadcast service, through the broadcast service ID.

In operation 824, the AF may newly allocate a primary TMGI and update the same. The updating may be performed for an operator servicing a TMGI other than the existing primary TMGI. A process in which the AF newly allocates a primary TMGI and updates the same may be performed through operations 828 to 884. The procedure in operations 828 to 884 corresponds to a procedure for updating a primary TMGI, based on the AF, and when a primary TMGI is initially allocated, a create message may be used rather than an update message used in operations 828 to 884. That is, for convince of description in FIG. 8, a process of updating a primary TMGI is described, but the same description is applicable to a case where a primary TMGI is initially allocated and generated.

In operation 828, for a TMGI other than the existing TMGI, the AF may transmit an Nnef_MBSSession_Update request message to the NEF. In operation 832, the NEF may transmit an Nmbsmf_MBSSession_Update request message to the MB-SMF. Accordingly, the AF may notify the MB-SMF of a newly selected primary TMGI. The request messages (e.g., the Nnef_MBSSession_Update request message and the Nmbsmf_MBSSession_Update request message) may include a newly selected primary TMGI other than the TMGI of the corresponding operator. In addition, the request messages (e.g., the Nnef_MBSSession_Update request message and the Nmbsmf_MBSSession_Update request message) may include a broadcast service ID to indicate a broadcast service.

In operation 836, the MB-SMF may configure a broadcast service data path with the MB-UPF. In operations 840a and 844a, the MB-SMF may transmit a response message to operations 828 and 832 to the AF, based on the configured path. That is, in operation 840a, the MB-SMF may transmit a response message (e.g., Nmbsmf_MBSSession_Update response) to operation 832 to the NEF, and in operation 844a, the NEF may transmit a response message (e.g., Nnef_MBSSession_Update response) to operation 828 to the AF. Alternatively, the response messages may be also transmitted to the AF through operations 840b and 844b after completion of configuration for up to the NG-RAN.

In operation 848, the MB-SMF may transmit an Namf_MB_SBroadcast_ContextUpdate request message to the AMF to notify the NG-RAN of the new primary TMGI. The request message (e.g., Namf_MBSBroadcast_ContextUpdate request) may include a new primary TMGI other than the TMGI of the corresponding operator, and may also include a broadcast service ID. In operation 852, the AMF may forward the received request message to the NG-RAN in the broadcast service area, or may transmit the request message corresponding to the received request message to the NG-RAN. The AMF may notify the new primary TMGI other than the TMGI of the corresponding operator, and the broadcast service ID through the message transmitted to the NG-RAN. In operation 856, the RAN sharing NG-RAN may update the MBS session context and update the primary TMGI. Thereafter, in operation 880, the RAN sharing NG-RAN may provide terminals with the broadcast service through the primary TMGI, instead of using the TMGI for the corresponding broadcast service.

In operation 860, the NG-RAN may transmit information on a tunnel for transmitting downlink broadcast traffic to the AMF as a response to the message received in operation 852. In addition, in operation 864, the AMF may transmit an Namf_MB_SBroadcast_ContextUpdate response message to the MB-SMF as a response to the message received in operation 848. The Namf_MB_SBroadcast_ContextUpdate response message may include tunnel information for transmitting the downlink broadcast traffic, the RAN sharing NG-RAN location information, the ID, etc. For example, the NG-RAN location information may include an ID, a cell ID, geographical location information, or geographical address information of the NG-RAN.

In operations 868 and 872, the MB-SMF may perform SM policy updating with the MB-PCF. In operation 876, the MB-SMF may perform N4bmb session updating with the MB-UPF. To avoid overlapping transmission to the NG-RAN when the N4mb session updating is performed and the TMGI is different from the new primary TMGI, the tunnel information for transmitting the downlink broadcast traffic may not be transmitted, or the N4mb session update including indication of deactivation of the downlink tunnel may be transmitted to the MB-UPF.

In operation 840b, the MB-SMF may transmit a result of the primary TMGI updating to the NEF. In operation 844b, the NEF may transmit a result of the primary TMBI updating to the AF. In this case, the message including the information on the result of the primary TMGI updating may include location information or ID of the RAN sharing NG-RAN, etc. In addition, the message may also include a broadcast service ID and a newly updated primary TMGI value.

In operation 884, the AF may transmit an MBS service announcement message to terminals. In operations 888 and 892, the RAN sharing NG-RAN may broadcast the broadcast service data to the terminals by using the newly updated primary TMGI. In operation 896, the terminals may receive the broadcast service. In this case, the terminals may be located in the RAN sharing NG-RAN area (e.g., the service area).

According to an embodiment, in the primary TMGI updating method of FIG. 8, the process of operations 864 to 844b among operations 828 to 884 for primary TMGI updating may be omitted in a case of a network of an operator of a TMGI other than the new primary TMGI.

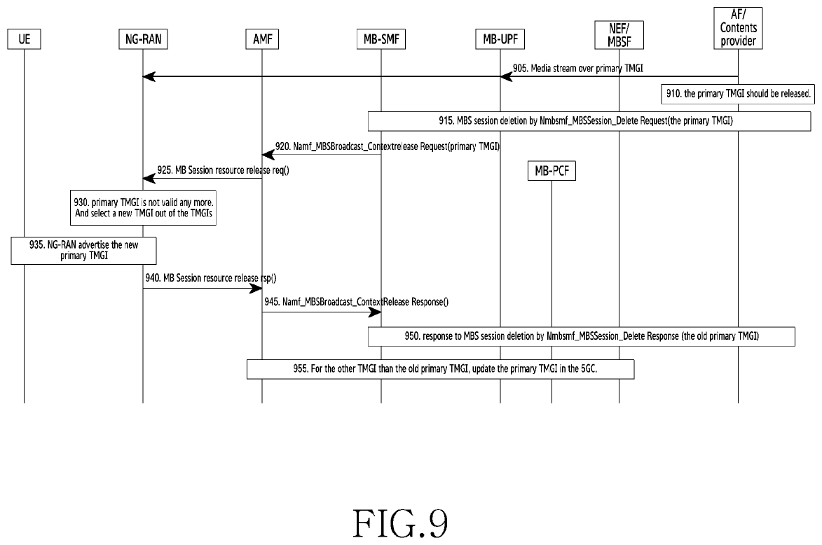

FIG. 9 illustrates an example of a method for updating a primary TMGI when an operator servicing the primary TMGI does not provide a service in a wireless communication system according to an embodiment of the present disclosure. Specifically, FIG. 9 illustrates an example of a method for updating a primary TMGI by an NG-RAN when an operator providing a service using the primary TMGI does not provide the service any longer in a wireless communication system.

A UE, an NG-RAN, an AMF, an MB-SMF, an MB-UPF, an NEF/MB SF, and an AF (contents provider), which are described in FIG. 9, may be understood to be identical to the network entities included in the 5GS 100 of FIG. 1. In addition, an MB-PCF of FIG. 9 may be understood to be substantially identical to the PCF 109 of FIG. 1. For example, the MB-PCF of FIG. 9 may refer to a PCF capable of providing a service related to an MBS in relation to the PCF 109 of FIG. 1.

In operation 905, the AF (or contents provider) may transmit broadcast service data to a RAN sharing NG-RAN. Although not shown in FIG. 9, the NG-RAN may broadcast broadcast service data to terminals through the primary TMGI.

In operation 910, when a broadcast service is no longer provided in a network of an operator of a TMGI corresponding to the primary TMGI, the TMGI may need to be released. In operation 915, the AF may transmit an Nmbsmf_MBSSession_Delete request with respect to the TMGI to the MB-SMF through the NEF. Accordingly, the AF may request to delete an MBS session for the broadcast service corresponding to the TMGI.

In operation 920, the MB-SMF may perform an Namf_MBSBroadcast_ContextRelease request for the TMGI. For example, for the TMGI, the MB-SMF may transmit an Namf_MBSBroadcast_ContextRelease request message to the AMF. In operation 925, the AMF may perform an MB session resource release request. For example, the AMF may transmit an MB session resource release request message to NG-RANs. The MB session resource release request message may include information for deleting the broadcast service corresponding to the TMGI.

In operation 930, the RAN sharing NG-RAN having been providing the broadcast service for the TMGI as the primary TMGI may identify that the service for the TMGI cannot be provided any longer. When continuing the same broadcast service as that of an operator other than the TMGI, the RAN sharing NG-RAN may select a new primary TMGI rather than the existing primary TMGI. Thereafter, in operation 935, the NG-RAN may broadcast a new primary TMGI.

In operation 940, the NG-RAN may perform a process of releasing the service for the TMGI through which the service cannot be provided any longer. For example, the NG-RAN may transmit an MB session resource release response message to the AMF. In operation 945, the AMF may transmit an Namf_MBSBroadcast_ContextRelease response message to the MB-SMF. In addition, in operation 950, the MB-SMF may transmit an Nmbsmf_MBSSession_Delete response message in response to an MB session deletion request. In this case, the Nmbsmf_MBSSession_Delete response message may include information on the TMGI, and the TMGI be an old primary TMGI.

In operation 955, as the new primary TMGI is configured, the NG-RAN may perform a procedure of updating the new primary TMGI for a TMGI other than the existing primary TMGI. Here, the procedure of updating the primary TMGI may mean the same procedure in operations 720 to 775 in FIG. 7. Accordingly, a detailed procedure of updating the primary TMGI is omitted in FIG. 9.

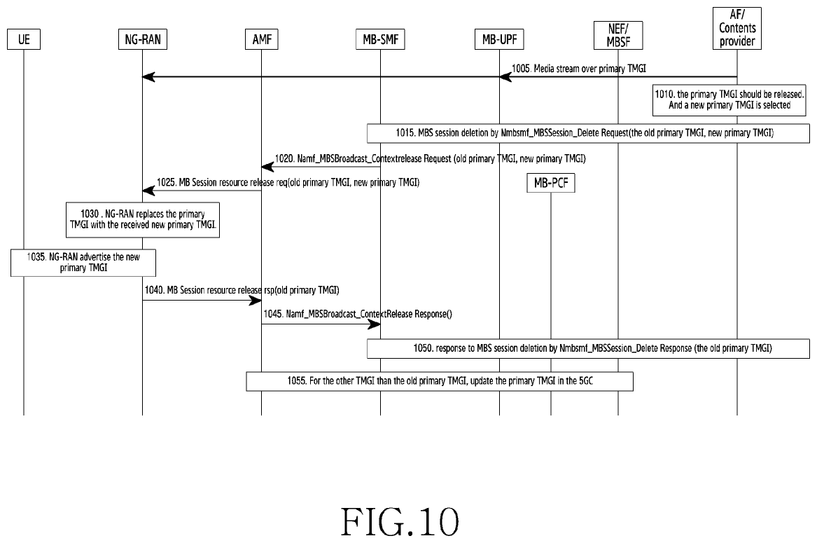

FIG. 10 illustrates another example of a method for updating a primary temporary mobile group identity (TMGI) when an operator servicing the primary TMGI does not provide a service in a wireless communication system according to an embodiment of the present disclosure. Specifically, FIG. 10 illustrates a process of a method for updating a primary TMGI by an AMF when an operator serving the primary TMGI does not provide a service any longer in a wireless communication system.

A UE, an NG-RAN, an AMF, an MB-SMF, an MB-UPF, an NEF/MB SF, and an AF (contents provider), which are described in FIG. 10, may be understood to be identical to the network entities included in the 5GS 100 of FIG. 1. In addition, an MB-PCF of FIG. 10 may be understood to be substantially identical to the PCF 109 of FIG. 1. For example, the MB-PCF of FIG. 10 may refer to a PCF capable of providing a service related to an MBS in relation to the PCF 109 of FIG. 1.

In operation 1005, the AF (or contents provider) may transmit broadcast service data to a RAN sharing NG-RAN. Although not shown in FIG. 10, the NG-RAN may broadcast broadcast service data to terminals through the primary TMGI.

In operation 1010, when a broadcast service is no longer provided in a network of an operator of a TMGI corresponding to the primary TMGI, the TMGI may need to be released. In operation 1010, the AF may identify that the TMGI having been used as the primary TMGI cannot be used to provide the service any longer, and select a new primary TMGI.

In operation 1015, the AF may transmit an Nmbsmf_MBSSession_Delete request with respect to the TMGI (old primary TMGI) to the MB-SMF through the NEF. Accordingly, the AF may request to delete an MBS session for the broadcast service corresponding to the TMGI. In operation 1020, for the TMGI, the MB-SMF may perform an Namf_MBSBroadcast_ContextRelease request to the AMF. For example, for the TMGI, the MB-SMF may transmit an Namf_MBSBroadcast_ContextRelease request message to the AMF. In operation 1025, the AMF may perform an MB session resource release request. For example, the AMF may transmit an MB session resource release request message to NG-RANs. Here, the MB session resource release request message may include information for deleting the broadcast service corresponding to the TMGI.

In the process of requesting to delete the service for the TMGI in operations 1015 to 1025, the request messages may include a newly selected primary TMGI (new primary TMGI). For example, through operations 1015 to 1025, the AF may transmit a new primary TMGI to the NG-RAN through the message for deleting the service for the existing TMGI. In operation 1030, the RAN sharing NG-RAN may update the primary TMGI with the new primary TMGI. Thereafter, in operation 1035, the NG-RAN may broadcast the new primary TMGI.

In operation 1040, the NG-RAN may perform a process of releasing the service for the TMGI (olde primary TMGI) through which the service cannot be provided any longer. For example, the NG-RAN may transmit an MB session resource release response message to the AMF. In operation 1045, the AMF may transmit an Namf_MBSBroadcast_ContextRelease response message to the MB-SMF. In addition, in operation 1050, the MB-SMF may transmit an Nmbsmf_MBSSession_Delete response message in response to an MBS session deletion request. In this case, the Nmbsmf_MBSSession_Delete response message may include information on the TMGI, and the TMGI may be an old primary TMGI.

In operation 1055, as the new primary TMGI is configured, the NG-RAN may perform a procedure of updating the new primary TMGI for a TMGI other than the existing primary TMGI. Here, the procedure of updating the primary TMGI may mean the same procedure in operations 828 to 896 in FIG. 8. Accordingly, a detailed procedure of updating the primary TMGI is omitted in FIG. 10.

As described above, according to embodiments of the disclosure, a method performed by a base station in a wireless communication system may include receiving information on a broadcast service related to a first primary temporary mobile group identity (TMGI) from an application function (AF), identifying whether updating to a second primary TMGI is required, the second primary TMGI being different from the first primary TMGI, transmitting a first message related to the second primary TMGI to an access and mobility management function (AMF) when the updating to the second primary TMGI is required, and receiving a second message related to the second primary TMGI from the AMF as a response to the first message, wherein the base station is shared between a first operator and a second operator to provide a service.

In an embodiment, the first operator may provide the broadcast service, based on the first primary TMGI and the second primary TMGI.

In an embodiment, the method may further include transmitting, to the AMF, a message for releasing a broadcast session for the first primary TMGI.

In an embodiment, the first message may include location information of the base station, an ID of the broadcast service, and tunnel information related to the broadcast service.

In an embodiment, the location information of the base station may include at least one of an ID of the base station, a cell ID, geographical location information, or geographical address information.

As described above, according to embodiments of the disclosure, a method performed by an application function (AF) in a wireless communication system may include transmitting information on a broadcast service related to a first primary temporary mobile group identity (TMGI) to a base station, receiving, from a network exposure function (NEF), a first message including information indicating that a broadcast session for the first primary TMGI has been released, and transmitting a second message including information on a second primary TMGI to the NEF, the second primary TMGI being different from the first primary TMGI, wherein the base station is shared between a first operator and a second operator to provide a service.

In an embodiment, the first operator may provide the broadcast service, based on the first primary TMGI and the second primary TMGI.

In an embodiment, the method may further include receiving, from the NEF, a response message to the second message.

In an embodiment, the response message may include location information of the base station, an ID of the broadcast service, and tunnel information related to the broadcast service.

In an embodiment, the location information of the base station may include at least one of an ID of the base station, a cell ID, geographical location information, or geographical address information.

As described above, according to embodiments of the disclosure, a method performed by a base station in a wireless communication system may include receiving information on a broadcast service related to a first primary temporary mobile group identity (TMGI) from an application function (AF), receiving, from an access and mobility management function (AMF), a first message including information for deletion of the broadcast service related to the first primary TMGI, identifying whether updating to a second primary TMGI is required, the second primary TMGI being different from the first primary TMGI, and transmitting information on the second primary TMGI, wherein the base station is shared between a first operator and a second operator to provide a service.

In an embodiment, the first operator may provide the broadcast service, based on the first primary TMGI and the second primary TMGI.

In an embodiment, the method may further include transmitting, to the AMF, a message for releasing a broadcast session for the first primary TMGI.

In an embodiment, the method may further include transmitting, to the AMF, a third message related to the second primary TMGI when the updating to the second primary TMGI is required, wherein the third message may include location information of the base station, an ID of the broadcast service, and tunnel information related to the broadcast service.

In an embodiment, the location information of the base station may include at least one of an ID of the base station, a cell ID, geographical location information, or geographical address information.

As described above, according to embodiments of the disclosure, a method performed by an application function (AF) in a wireless communication system may include transmitting information on a broadcast service related to a first primary temporary mobile group identity (TMGI) to a base station, identifying whether updating to a second primary TMGI is required, the second primary TMGI being different from the first primary TMGI, and transmitting, to a session management function (SMF) through a network exposure function (NEF), a first message including information for deletion of the broadcast service related to the first primary TMGI, wherein the first message includes information on the second primary TMGI, and the base station is shared between a first operator and a second operator to provide a service.

In an embodiment, the first operator may provide the broadcast service, based on the first primary TMGI and the second primary TMGI.

In an embodiment, the method may further include receiving, from the NEF, a response message to the first message, wherein the response message includes information on the first primary TMGI.

In an embodiment, the method may further include transmitting, to the NEF, a second message including information on the second primary TMGI, and receiving a response message to the second message, wherein response message to the second message may include location information of the base station, an ID of the broadcast service, and tunnel information related to the broadcast service.

In an embodiment, the location information of the base station may include at least one of an ID of the base station, a cell ID, geographical location information, or geographical address information.

The methods according to the embodiments described in the claims or the specification of the disclosure may be implemented in software, hardware, or a combination of hardware and software.

As for the software, a computer-readable storage medium storing one or more programs (software modules) may be provided. One or more programs stored in the computer-readable storage medium may be configured for execution by one or more processors of an electronic device. One or more programs may include instructions for controlling an electronic device to execute the methods according to the embodiments described in the claims or the specification of the disclosure.

Such a program (software module, software) may be stored to a random access memory, a non-volatile memory including a flash memory, a read only memory (ROM), an electrically erasable programmable ROM (EEPROM), a magnetic disc storage device, a compact disc (CD)-ROM, a digital versatile disc (DVD) or other optical storage device, and a magnetic cassette. Alternatively, it may be stored to a memory combining part or all of those recording media. A plurality of memories may be included.

Also, the program may be stored in an attachable storage device accessible via a communication network such as internet, intranet, local area network (LAN), wide LAN (WLAN), or storage area network (SAN), or a communication network by combining these networks. Such a storage device may access a device which executes an embodiment of the disclosure through an external port. In addition, a separate storage device on the communication network may access the device which executes an embodiment of the disclosure.

In the specific embodiments of the disclosure, the components included in the disclosure are expressed in a singular or plural form. However, the singular or plural expression is appropriately selected according to a proposed situation for the convenience of explanation, the disclosure is not limited to a single component or a plurality of components, the components expressed in the plural form may be configured as a single component, and the components expressed in the singular form may be configured as a plurality of components.

Meanwhile, while the specific embodiment has been described in the explanations of the disclosure, it will be noted that various changes may be made therein without departing from the scope of the disclosure. Therefore, the scope of the disclosure is not limited and defined by the described embodiment and is defined not only the scope of the claims as below but also their equivalents.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Furthermore, the above respective embodiments may be employed in combination, as necessary. For example, a part of one embodiment of the disclosure may be combined with a part of another embodiment to operate a base station and a terminal. As an example, a part of embodiment 1 of the disclosure may be combined with a part of embodiment 2 to operate a base station and a terminal. Furthermore, although the above embodiments have been presented based on the FDD LTE system, other variants based on the technical idea of the above embodiments may also be implemented in other systems such as TDD LTE, 5G, or NR systems.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

Furthermore, in methods of the disclosure, some or all of the contents of each embodiment may be implemented in combination without departing from the essential spirit and scope of the disclosure.

Various embodiments of the disclosure have been described above. The above description of the disclosure is merely for the sake of illustration, and embodiments of the disclosure are not limited to the embodiments set forth herein. Those skilled in the art will appreciate that the disclosure may be easily modified and changed into other specific forms without departing from the technical idea or essential features of the disclosure. Therefore, the scope of the disclosure should be determined not by the above detailed description but by the appended claims, and all modification sand changes derived from the meaning and scope of the claims and equivalents thereof shall be construed as falling within the scope of the disclosure.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a base station in a wireless communication system, the method comprising:
identifying that a multicast and broadcast service (MBS) service of a first broadcast MBS session is not available;
identifying a second broadcast MBS session which is different from the first broadcast MBS session for the MBS service;
transmitting, to an access and mobility management function (AMF) entity, information on the second broadcast MBS session;
receiving, from the AMF entity, information on a broadcast MBS session allocated based on the information on the second broadcast MBS session; and
receiving, from a multicast/broadcast user plane function (MB-UPF) entity, an MBS data of the MBS service,
wherein the information on the second broadcast MBS session is transmitted to the MB-UPF via a multicast/broadcast-session management function (MB-SMF) entity, and
wherein the base station is a shared base station for the MBS service.

2. The method of the claim 1, wherein the second broadcast MBS session is identified in case that the first broadcast MBS session is released or in case that a reception of the MBS data via the first broadcast MBS session fails.

3. The method of the claim 1, wherein the information on the second broadcast MBS session includes an identity of the second broadcast MBS session and information on a downlink tunnel associated with the second broadcast MBS session.

4. The method of the claim 3, wherein the MBS data is received by a unicast transport via the downlink tunnel.

5. The method of the claim 1, wherein the first broadcast MBS session is associated with at least one of a core network operating the base station, a core network with a largest number of subscribed UEs in a MBS service area, or a core network with a highest facility contribution.

6. A method performed by a multicast and broadcast-session management function (MB-SMF) entity in a wireless communication system, the method comprising:
receiving, from an access and mobility management function (AMF) entity, information on a second broadcast multicast and broadcast service (MBS) session which is different from a first broadcast MBS session for a MBS service in case that the MBS service of a first broadcast MBS session is not available;
allocating a broadcast MB S session based on the information on the second broadcast MBS session; and
transmitting, to MB-user plane function (UPF) entity, information on the broadcast MBS session,
wherein an MBS data of the MBS service is transmitted based on the information on the broadcast MBS session, and
wherein the base station is a shared base station for the MBS service.

7. The method of the claim 6, wherein the second broadcast MBS session is identified in case that the first broadcast MBS session is released or in case that a reception of an MBS data via the first broadcast MBS session fails.

8. The method of the claim 6, wherein the information on the second broadcast MBS session includes an identity of the second broadcast MBS session and information on a downlink tunnel associated with the second broadcast MBS session.

9. The method of the claim 8, wherein the MBS data is transmitted by a unicast transport via the downlink tunnel.

10. The method of the claim 6, wherein the first broadcast MBS session is associated with at least one of a core network operating the base station, a core network with a largest number of subscribed UEs in a MBS service area, or a core network with a highest facility contribution.

11. A base station in a wireless communication system, the base station comprising:
a transceiver; and
at least one processor coupled with the transceiver and configured to:
identify that a multicast and broadcast service (MBS) service of a first broadcast MBS session is not available,
identify a second broadcast MBS session which is different from the first broadcast MBS session for the MBS service,
transmit, to an access and mobility management function (AMF) entity, information on the second broadcast MBS session,
receive, from the AMF entity, information on a broadcast MBS session allocated based on the information on the second broadcast MBS session, and
receive, from a multicast/broadcast user plane function (MB-UPF) entity, an MBS data of the MBS service,
wherein the information on the second broadcast MBS session is transmitted to the MB-UPF entity via a multicast/broadcast-session management function (MB-SMF) entity, and
wherein the base station is a shared base station for the MBS service.

12. The base station of the claim 11, wherein the second broadcast MBS session is identified in case that the first broadcast MBS session is released, or in case that a reception of the MBS data via the first broadcast MBS session fails.

13. The base station of the claim 11, wherein the information on the second broadcast MBS session includes an identity of the second broadcast MBS session and information on a downlink tunnel associated with the second broadcast MBS session.

14. The base station of the claim 13, wherein the MBS data is received by a unicast transport via the downlink tunnel.

15. The base station of the claim 11, wherein the first broadcast MBS session is associated with at least one of a core network operating the base station, a core network with a largest number of subscribed UEs in a MBS service area, or a core network with a highest facility contribution.

16. A multicast/broadcast-session management function (MB-SMF) entity in a wireless communication system, the MB-SMF entity comprising:
a transceiver; and
at least one processor coupled with the transceiver and configured to:
receive, from an access and mobility management function (AMF) entity, information on a second broadcast multicast and broadcast service (MBS) session which is different from a first broadcast MBS session for a MBS service in case that the MBS service of a first broadcast MBS session is not available;
allocate a broadcast MBS session based on the information on the second broadcast MBS session; and
transmit, MB-user plane function (UPF) entity, information on the broadcast MBS session,
wherein an MBS data of the MBS service is transmitted based on the information on the broadcast MBS session, and
wherein the base station is a shared base station for the MBS service.

17. The MB-SMF entity of the claim 16, wherein the second broadcast MBS session is identified in case that the first broadcast MBS session is released, or in case that a reception of the MBS data via the first broadcast MBS session fails.

18. The MB-SMF entity of the claim 16, wherein the information on the second broadcast MBS session includes an identity of the second broadcast MBS session and information on a downlink tunnel associated with the second broadcast MBS session.

19. The MB-SMF entity of the claim 18, wherein the MBS data is transmitted by a unicast transport via the downlink tunnel.

20. The MB-SMF entity of the claim 16, wherein the first broadcast MBS session is associated with at least one of a core network operating the base station, a core network with a largest number of subscribed UEs in a MBS service area, or a core network with a highest facility contribution.
